(19) United States
(12) Patent Application Publication
(10) Pub. No.: US 2004/0096808 A1
(43) Pub. Date: May 20, 2004

(54) Communication assist device

(76) Inventors: Amy J. Price, Columbus, OH (US); Ann E. Brown, Westerville, OH (US)

Correspondence Address: Sean M. Casey Co., L.P.A., Attention: Sean M. Casey, P.O. Box 710, New Albany, OH, 43054-0710, US

(21) Appl. No.: 10/301,525

(22) Filed: Nov. 20, 2002

(51) Int. Cl. G09B 21/00

(52) U.S. Cl. 434/112; 434/365

(57) ABSTRACT

A communication assist device that includes, among other features and elements, a cover carried from a strap and that incorporates a stylized outside covering imprinted with a preselected pattern indicia for improved appearance. The device further includes a plurality of releasably or fixedly bound and transparent pocket pages having an accessible interior pocket or interstice sized to receive one or more of a plurality of indicia sheets. The sheets are preferably to be retained in the interior pocket during use to be observable through the sheet material. Each of the indicia sheets are also preferably imprinted with a plurality of indicia selected from categories of indicia that include an alphabet, a character set, numbers, arithmetic and mathematical symbols, dimension measurement units, metaphoric icons, images, pictures, graphics, symbols, glyphs, phonemes, words, phrases, sentences, wherein such categories of indicia are preselected to depict people, places, things, actions, activities, weather, food, emotions, business, academics, sports, and medicine and healthcare. The instant invention may also preferably or optionally include retainers in the cover, in the pocket pages, and or formed as a replacement to a pocket page for incorporating a retainer that receive an interactive data device such as a Palm Pilot® or similarly capable data device. In yet other configurations, the instant invention can also incorporate any of a number of audio playback devices that can be button actuated and battery powered, which can record or be recorded with preselected audio segments that can be desired sounds, words, phrases, sentences, and the like.

### TECHNICAL FIELD

This invention relates to systems, tools, and devices adapted for augmentative communication applications where an individual is challenged with one or more language, vocal, oral, or verbal speech and communication impairments that can be mitigated with augmentative communication assist devices and systems.

### BACKGROUND OF THE INVENTION

In the past, various attempts have been to improve the state of the art of augmentative communication aids and devices that can be used by those challenged by one or more language, speech, and vocalization anomalies. In the context of language barriers that can exist between people who speak different languages, such as Chinese and English, some individuals have created language communication aids using symbolic and pictogrammatic representations of every day items, people, places, things, actions, questions, and answers. One such effort is described by Glass et al. in U.S. Pat. No. 3,871,115, which is limited to, among other restrictions, to a flip-chart device that is preprinted with various phrases in both languages, as well as pictures that represent certain items that when combined with the dual language phrases, can be used to by people who do not speak the same language to communicate about every day matters. One of the limitations demonstrated by the Glass et al. device is that it must be preprinted with both languages of interest and that it can only be used by an individual knowledgeable and able to communicate in at least one of the languages. Accordingly, one such '115 device is needed for each additional language that may be encountered.

In another prior art genre of communication aids, Leff teaches in U.S. Pat. No. 4,165,890 an assembly of illustrations that are mounted to an “O” ring. As Leff explains, his device is limited to such illustrations being received in a transparent plastic pocket envelope that can be displayed by an individual for purposes of communicating basic needs and wants when speech is impaired. As with the Glass et al. '115 device already described, the Leff '890 device can be limited in effectiveness by the dexterity of the user. Additionally, like the Leff '890 device, some likely candidates for using such a device may be discouraged adopting use because of its seemingly unwieldy configuration.

In addition to basic communication aids like the Neff '890 device, and the trans-language communication devices described by Glass et al., others have directed their attentions to communication systems directed to teaching and improving the language and communication skills of nonverbal individuals and those challenged with speech, language, and vocalization impediments. One such device is disclosed by Fletcher in U.S. Pat. No. 6,056,549, which is limited to a multi-paged book of support pages adapted to removably receive what Fletcher describes as demonstration pieces. The Fletcher demonstration pieces are described as being imprinted with informative indicia that depict common objects, activities, statements, phrases, questions, answers, and similar items. Any of the hundreds of indexed demonstration pieces depicted by Fletcher can be removably arrayed and attached to the support pages in the book for purposes of defining a question or statement that can be communicated between multiple individuals for purposes of teaching language and communication skills.

Those with skill in the art of communication augmentation devices, among others, have long felt that devices such as those illustrated above have suffered from many shortcomings that have precluded widespread adoption and use by those needing such device the most. Further, those knowledgeable in the relevant arts have long-recognized the need for an improved method and device for assisting language, vocalization, speech, and developmentally challenged individuals in their day-to-day communication needs.

To achieve more willing acceptance and adoption of such communication assistance devices by those who could benefit and who need such devices the most, the problems in the prior art must be overcome to establish a device that is flexible, efficient, and easy to use, attractive in appearance, effective in operation, and that is preferably reconfigurable and customizable by the user. Those skilled in the art recognize the most individuals that are confronted with various communication challenges are reluctant to use present-day communication augmentation devices because such devices are cumbersome and usually identify the user as someone having a communication issue, which identification only serves to exacerbate feelings of inadequacy and inferiority. Moreover, even if such issues were not a concern, present day communication assist devices often include an unwieldy number of components, such as those in the Fletcher device whereby the individual must master the location of hundreds of images before communication can be established.

What has been needed but as yet unavailable is a augmentative communication device that addresses some of the long-standing problems in the art noted herein. The need remains for a communication device that can be readily adapted to the particular needs of the individual who is to use the device. A device is also needed that does not serve as an additional impediment to communication by its very appearance. Further, a communication device is needed that is compatible for use in any of a number of applications that can include teaching and learning, trans-language communication applications, and for purposes of assisting nonverbal and speech, language, or developmentally challenged individuals.

The present invention meets the above described and other needs in new and novel ways without adding any increased costs, difficulties in use, and is adapted for use in existing applications and environments as an additional augmentative tool that can benefit users, teachers, and everyone challenged by the communication impediment that may be at issue. The communication assist device of the instant invention is also readily compatible for use with any of a number of more technologically sophisticated avenues of communication assistance, which can include audio playback support devices and interactive data devices such as palm computers and information devices. The various embodiments and alternative arrangements of the present invention as disclosed herein evidence ease of manufacture, desirable fabrication costs, easy operation and use by a wide range of prospective users, and wide compatibility with various existing teaching, learning, and augmentative communication protocols, methods, and devices. Even better, the instant invention also establishes a communication assistance device that is attractive in appearance and that remains unobtrusively and conveniently available to the user until needed.

### SUMMARY OF INVENTION

In its most general configuration, the present invention advances the state of the art with a variety of new capabilities and overcomes many of the Shortcomings of prior devices in new and novel ways. In one of the many preferable configurations, a communication assist device according to the principles of the instant invention includes a cover that is formed with a front and a back portion, which are joined together longitudinally about a spine. The cover also preferably includes an outer surface that is formed with a preselected pattern indicia to establish an attractive outward appearance. A lateral carrying strap is also included that can be adjustable and used for hand or shoulder carrying, and that can also be adapted to attached to a back pack or other carrying device.

Between the front and back portions of the cover, a plurality of pocket pages are included that are made from a substantially transparent and flexible plastic or cellulosic sheet material. The pocket pages are bound about respective inside edges to the cover adjacent to or on the spine of the cover. Preferably, each pocket page of the plurality are also formed with at least one aperture that opens into an interior recess, pocket, or interstice that is defined between at least two pieces of confrontingly registered sheet material of the pocket page. The aperture or opening can be formed about any edge of the pocket page and is preferably formed about an inside edge so as to prevent the contents of the interior pocket or recess from falling out. Additionally, the pocket pages of the plurality may also be formed with permanent or releasable closure elements about the aperture or opening that can be implemented to positively close the aperture.

The preferred communication assist device also preferably includes one or more or a plurality of indicia sheets that are sized to be inserted through the aperture of the pocket page to be retained in the pocket or interstice. Once inserted and retained, the indicia sheets are observable through the pocket page sheet material. In any of a number of possible variations of the instant invention, two back-to-back indicia sheets can be inserted into the pocket or interstice so that each side of the pocket page will present a different indicia sheet.

Each of the plurality of indicia sheets are preferably imprinted with at least one, or more than one indicia that are selected from at least one category of such indicia. Such categories contemplated for use in the context of the instant invention include, for purposes of example but not for purposes of limitation, an alphabet, a character set, numbers, arithmetic and mathematical symbols, dimension measurement units, metaphoric icons, images, pictures, graphics, symbols, glyphs, phonemes, words, phrases, sentences, wherein such categories of indicia are preselected to depict people, places, things, actions, activities, weather, food, emotions, business, academics, sports, and medicine and healthcare.

For purposes of compatibility of the communication assist device according to the instant invention, the cover can also further incorporate at least one retainer for releasably receiving at least one interactive data device. The contemplated retainer can be formed on the inside or the outside surfaces of the front and back portions of the cover and is preferably sized to receive one or more types of interactive devices, such as, for purposes of illustration without limitation, and Palm Pilot® available from Palm Computing, Inc., USA. Preferably, the retainer is configured to form a pocket that can receive and releasably retain the interactive data device and such that the device can be used and operated when so retained. In other alternative arrangements, the retainer device may also incorporate one or more features to releasably retain a stylus or similar component, such as that used by a Palm Pilot® to interactively operate the device.

In yet another alternative arrangement suitable for use with any of the preceding embodiments, either alone or in combination therewith, at least one of the plurality of pocket pages may be adapted to have at least one retainer to releasably receive the at least one interactive data device. In this way, one or more such interactive data devices may be incorporated into the contemplated communication assist device, which can be especially useful in teaching applications where an instructor may include one interactive data device that is programmed as a teaching device similar to that used by individuals meeting their respective communication challenges, while another such interactive data device can be programmed with additional data and software that can be useful for instructors in recording progress, annotating student files, and for retaining work-in-progress tutorials and other materials that may not be ready for student use. In other modifications to any of the preceding variations and embodiments, in place of or in addition to a date device retainer being formed in the cover or as part of the contemplated pocket pages, such a retainer may also be formed as a replacement to a pocket page and attached to the communication assist device in the same manner as a pocket page.

The communication assist device according to principles of the instant invention is also directed to, among other features and embodiments, a configuration wherein at least one of the plurality of imprinted indicia of the indicia sheets, or even an entire indicia sheet, are replaced with one or more or at least one audio emitting device that can be an audio playback device. The contemplated device can be a battery operated, push button actuated audio device that can emit, for purposes of example without limitation, a 4-bit, 8-bit, or other format audio segment. Such an audio segment can be a prerecorded sound, phoneme, word, phrase, or sentence.

The audio device may also be adapted whereby it can interactively record a sound, and then playback the recorded sound. Additionally, the preferred or optional audio device may be configured to playback preprogrammed audio segments as well as record and playback other desired audio segments. In any of such configurations, variations, and modifications to any of the preceding embodiments, the contemplated audio playback or emitting device can be used either alone or in combination with the described indicia to further augment the learning, verbalization, language, speech, and vocalization capability of the challenged user as well as the teaching and instruction capability of the language and speech professor, instructor, therapist, coach, or pathologist.

For further improved capabilities, in configurations of the instant invention that include the audio emitting and playback device, at least one of the pockets pages of the plurality can be preferably or optionally formed with one or more holes that are positioned to be registered over the at least one audio playback device when it is received in the interior pocket or interstice of the pocket page so that the playback device is actuatable through the one or more holes. This can be a useful feature in embodiments of the communication assist device that incorporate more durable and perhaps thicker materials as elements of the pocket pages for use with smaller children and in more harsh environments. In such configurations that use thicker sheet materials for fabricating the pocket pages, the buttons or switches of the contemplated audio emitting device may be more easily accessed and actuated through holes that can be formed in the sheet of the pocket pages.

In other variations of any of the previously illustrated embodiments and modifications thereto, the communication assist device may be formed with at least one of the plurality of pocket pages being releasably attached to the spine. Also, the carrying strap can be further adapted to be interchangeably connected to the cover whereby the communication assist device can be carried from the strap in a spine inferior and a spine superior orientation. In combination with the selected aperture location that is formed on the pocket page, the communication assist device can be carried in an orientation that best prevents the indicia sheets from inadvertently falling from the interior pocket or interstice while the assist device is being carried about and transported from one location to another. The instant invention may also be optionally or preferably modified so as to incorporate a closure element that releasably secures and closes the front and back portions of the cover in a confrontingly arrangement, which thereby sandwiches the plurality of pocket pages together. The closure element can be, for purposes of illustration but not limitation, a hook and loop type fastener, snap fastener, twist post and hole fastener, a tie fastener, latch fastener, and the like.

These variations, modifications, and alterations of the various preferred embodiments may be used either alone or in combination with one another as can be better understood by those with skill in the art with reference to the following detailed description of the preferred embodiments and the accompanying figures and drawings.

### BRIEF DESCRIPTION OF THE DRAWINGS

Without limiting the scope of the present invention as claimed below and referring now to the drawings and figures, wherein like reference numerals across the several drawings, figures, and views refer to identical, corresponding, and or equivalent elements, features, components, and parts:

FIG. 1 is an elevation view, in reduced scale, of a communication assist device according to the present invention and shown in an opened arrangement for purposes of illustration;

FIG. 2 is an elevation view, in reduced scale, of the communication assist device of FIG. 1 in a generally closed configuration and illustrating a stylized covering;

FIG. 3 is a plan view of a component of the communication assist device of FIG. 1; and

FIG. 4 is a plan view of another component of the communication assist device of FIG. 1.

Also, in the various figures and drawings, various reference numerals, symbols, and letters are used to identify significant features, dimensions, components, capabilities, and arrangements of elements described herein below in connection with the several figures and illustrations.

### DETAILED DESCRIPTION OF THE INVENTION

The communication assist device according to the principles of the instant invention presents a significant leap forward in the field of augmentative verbalization, vocalization, language, and speech communication assist devices. Many undesirable, ineffective, and unsuccessful attempts have been made to create such a device that have met with only limited success and even more restricted acceptance among individuals seeking to address their communicative challenges. The preferred communication assist device of the instant invention has wide application for all such individuals and has demonstrated unexpected improvements in previously recalcitrant individuals seeking to avoid further stigmatization from use of other large, unwieldy, and cumbersome to use prior art devices.

The preferred embodiments and described alternatives, modifications, and variations of the inventive and novel communication assist device of the instant invention alone and together overcome prior shortcomings and accomplish new and novel solutions to the prior art shortfalls with vastly improved configurations and arrangements of inventive features and elements that are uniquely for use by a wide range of individuals. The assist device of the instant invention demonstrates previously unavailable flexibilities and capabilities, and has wide compatibility for use with any existing teaching, learning, and communication methods, protocols, and applications.

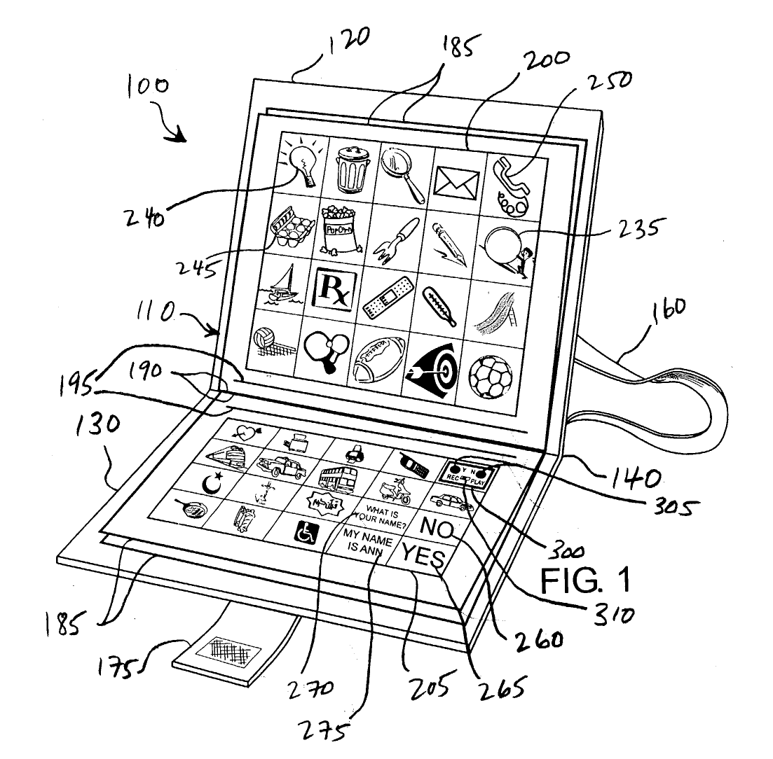

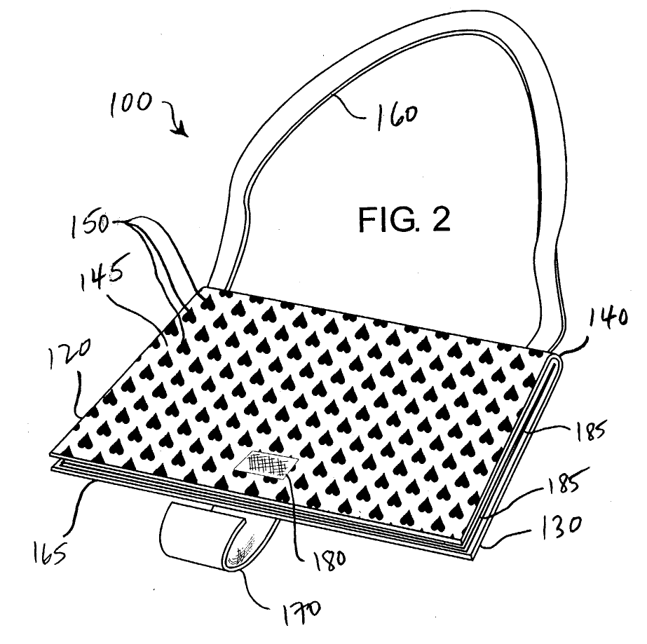

With reference now to the accompanying figures and specifically to FIGS. 1 and 2, in one of the many preferable configurations, the communication assist device and apparatus 100 incorporates, among other features, components, and elements, a cover 110 that is assembled from front and back portions 120, 130, which are pivotally joined together about a generally longitudinal a spine portion 140. An outer covering and or surface 145 of the cover 110 is formed with or imprinted with one or more preselected and preferred and desired decorative and stylish indicia 150 that be any pattern, texture, finish, embossment, material, and combination thereof, which can serve to vastly increase the likelihood that a user or individual needing to use the device 100 will actually adopt and use it on a regular and continuing basis. Such outer coverings and or surfaces 145 can be formed from wood, metal, leather, cloth, an embossed thermoplastic material, and other materials, and combinations thereof, to establish an unlimited number of possible variations of such coverings and surfaces 145 so as to appeal to the wide range of tastes and preferences of prospective individuals that may need the device 100.

The cover also preferably includes a lateral carrying strap 160 that can be fixedly or releasably and interchangeably attached to the communication assist device 100 Although shown in a fixed length configuration in the various view and figures, the instant invention is also directed to variations of the strap 160 that can be adjustable in length for hand and shoulder carrying configurations, and that can include other attachment devices (not shown) that can be adapted to attach the strap 160 and the assist device 100 to other carrying items such as backpacks, book bags, purses, satchels, brief cases, and similar items. Although also shown in the various figures as being adapted for fixed attachment to the cover 110, the strap 160 may also be interchangeably attached so that various length, width, and design imprinted or woven straps can be interchanged so as to offer a broad selection of possible strap configurations and capabilities to prospective users. The carrying strap 160 contemplated herein can also be further adapted for interchangeability whereby the it may be connected in more than one fashion so that the communication assist device 100 can be carried from the strap 160 in a spine superior orientation as is reflected in FIGS. 1 and 2. In this arrangement, as the communication assist device 100 is carried from the strap 160, the spine 140 is oriented above and directed generally upward. In alternative arrangements not shown in the figures but within the comprehension of those having skill in the art, the strap 160 may be attached to the cover 110 from the opposite edge 165 (FIG. 2) from the spine 140. In this alternative variation of any of the preceding embodiments, the spine 140 would be carried in a generally inferior orientation relative to the other components of the communication assist device 100.

As can be understood with continued reference to FIGS. 1 and 2, the preferred communication assist device according to the principles of the instant invention may be optionally or preferably configured to incorporate one or more closure elements such as closure element or tab 170. The closure element 170 is preferably adapted to releasably secure, close, and fasten the front and back portions 120, 130 of the cover 110 in a confrontingly relationship. For continued purposes of illustration but not for purposes of limitation, the closure element or tab 170 may further incorporate one or more fasteners, such as hook and loop type fasteners 175, 180 (FIGS. 1, 2). Alternative configurations also include in place of or in combination with the hook and loop type fasteners 175, 180, one or more snap fasteners, twist post bayonet and hole type fasteners, tie fasteners, latch fasteners, and similarly capable fasteners known to those skilled in the relevant arts.

Although the instant invention contemplates of variety of sizes, shapes, and dimensions of communication assist devices 100 beyond that substantially rectangular configuration shown in the various figures, one particularly well-received embodiment of the device 100 that has demonstrated great strides forward in terms of acceptance by those individuals needing to use such devices, has been configured in a substantially rectangular profile similar in many respects to that illustrated in the various figures. Additionally, it has been shown that among many possible sizes and dimensions that have been similarly well-received by users, a configuration having a generally longitudinal dimension of about 6 inches and a substantially lateral dimension of about 4 inches is a suitable arrangement.

The instant communication assist device 100 also further includes a plurality of pocket pages 185 that are preferably fabricated from a substantially flexible and generally optically transparent sheet material that can be formed from a thermoplastic, acetate, or cellulosic or another material having similarly desirable characteristics, and from combinations of such materials as may be preferred for particular applications. For further illustrative purposes without limiting the possible materials that are suitable for purposes of the instant invention, such materials can even more preferably be formed from a polypropylene sheet material.

In one of many possible and preferred configurations, the pocket pages 185 are fixedly or releasably bound about respective inside edges 190 to the cover 110 on or proximate to the spine 140 of the cover 110. In most configurations, each pocket page 185 of the contemplated plurality are also formed with at least one aperture 195 that opens into an interior recess, pocket, or interstice that is defined between at least two plies of the flexible and transparent material that is selected to form the pocket page 185 and which plies or multiple sheets of material are arranged in a confrontingly registered relationship much like what are commonly referred to by those having skill in the art as sheet protectors, which are available from most office supply vendors.

The aperture or opening 195 can be formed about any edge of the pocket page 185 and is preferably formed about and proximate to the inside edge 190. In this optionally or preferred arrangement, the contents of the interior pocket or recess of the pocket page 185 can be prevented from falling out when the communication assist device 100 is carried in the spine superior orientation described hereinabove. In alternative configurations, the opening or aperture can be formed in any other suitable or desire edge of the pocket page 185 and can be further adapted to incorporate one or more positive aperture sealing components (not shown but known to those having skill in the art) that can be selected from the group that includes, for purposes of further illustration without limitation, sliding zipper-type closures, tongue and groove aperture sealing devices, releasable adhesive strips that cooperate to seal the aperture 195, and similarly capable features. One particularly well-adapted sliding zipper and tongue and groove-type closure component is well-known to those skilled in art as a “ZIP-LOC®” fastener, which is formed in a variety of plastic bags that are available from a number of American commercial vendors and suppliers. In any of a number of possibly suitable and preferred and optional configurations of any of the preceding embodiments and modifications thereto, an effective combination of possible aperture 195 locations and carrying orientations and aperture closure elements (not shown) can be incorporated so as to achieve the most optimal performance of the particularly configured communication assist device 100 according to the principles of the instant invention.

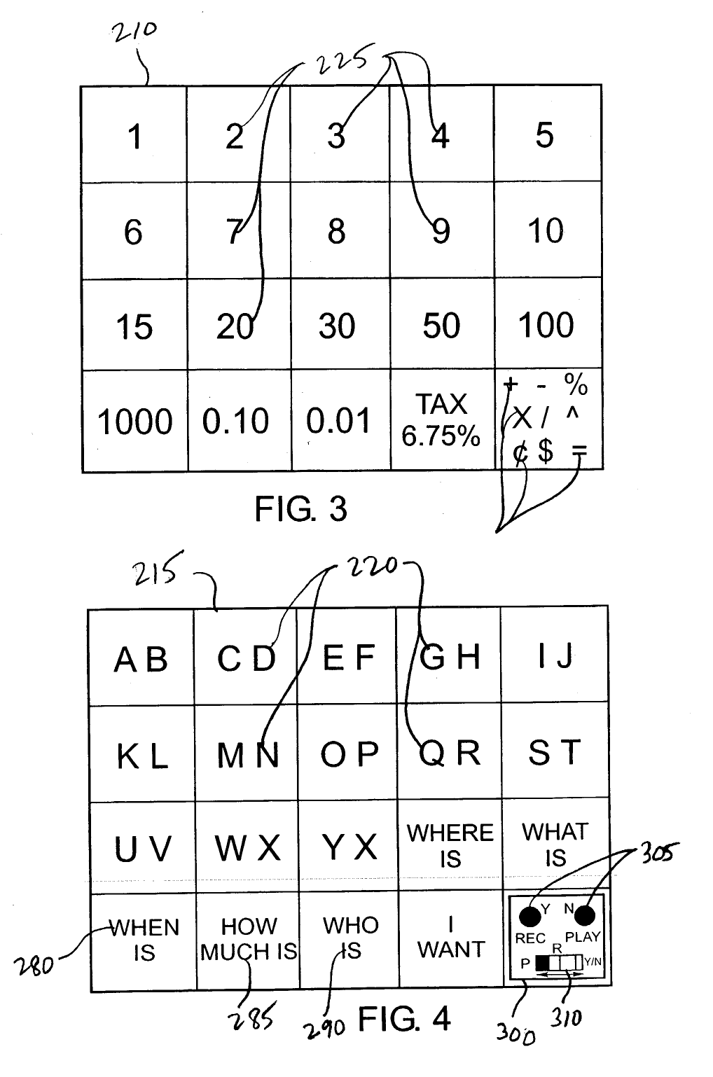

With continued reference to the various figures and now also to FIGS. 3 and 4, those skilled in the art may further be able to comprehend that the preferred communication assist device 100 also preferably includes one or more or a plurality of indicia sheets 200 (FIG. 1), 205 (FIG. 1), 210 (FIG. 3), 215 (FIG. 4). The indicia sheets 200, 205, 210, 215 are preferably sized to be inserted through the aperture 195 of the pocket page 185 to be retained in the pocket or interstice.

In use, the preferred indicia sheets 200, 205, 210, 215 are inserted and retained in the interior pocket or interstice of the pocket page 185 to be observable through the sheet material that forms the pocket page 185. In any of a number of possible modifications to any of the preceding embodiments and variations, two back-to-back indicia sheets, such as indicia sheets 200, 205, 210, 215, can be inserted into the pocket or interstice so that each side of the pocket page 185 displays a different indicia sheet, such as indicia sheets 200, 205, 210, 215.

As noted generally herein elsewhere, each of the plurality of indicia sheets 200, 205, 210, 215 are preferably imprinted or embossed or otherwise marked with at least one, or more than one depictions or indicia that are selected from at least one category of subject matter that is employed to index and organize such descriptive indicia. More specifically, and for further purposes of illustration and explication but not for purposes of limitation, such categories contemplated for use in the context of the communication assist device 100 according to th, guidelines and examples of the instant invention can include an alphabet 220 (sheet 215, FIG. 4), a character set for a non-English language communication system, numbers 225 (sheet 210, FIG. 3), currency and arithmetic and mathematical symbols 230 (sheet 210, FIG. 3), dimension measurement units (e.g. pounds, feet, gallons, etc.), metaphoric icons 235 (“as difficult as rolling a stone uphill”, see, e.g., sheet 200, FIG. 1), graphics and pictures and images 240, 245, 250, 255 (sheets 200, 205 FIG. 1), symbols, glyphs, phonemes, words 260 and 265 (sheet 205, FIG. 1), and sentences and phrases 270 and 275 (sheet 205, FIG. 1), 280 and 285 and 290 (sheet 215, FIG. 4). Such categories of indicia are preselected to depict people, places, things, actions, activities, weather, food, emotions, business, academics, sports, and medicine and healthcare, to name just a few exemplary possibilities. Although not shown grouped or organized substantially by such categories, the sheets according to the instant invention, such as exemplary indicia sheets 200, 205, 210, 215, can be organized with user favorite indicia grouped in sheets by individual preferences, by groups best suited to augment communication as a function of the particular challenge faced by the user or individual using the device 100, or by groupings that organize the contemplated indicia by general category of subject matter as described herein, or in any combination thereof. Although not shown in the various figures, the instant invention is also directed to an automated, computerized library of such depictions and descriptive indicia that can be selected, grouped, and printed onto indicia sheets, such as indicia sheets 200, 205, 210, 215 so as to produce customized augmentative indicia sheets suited to the particular user. Such an automated and computerized library can be made available over the internet to subscribers and purchasers of the contemplated communication assist device 100 of the instant invention.

For purposes of compatibility of the communication assist device 100 according to the instant invention, the cover 110 can also further incorporate at least one retainer (not shown) for releasably receiving at least one interactive data device (not shown but known to those skilled in the relevant arts and as further described herein). The contemplated retainer can be formed on the inside or the outside surfaces of the front and back portions 120, 130 of the cover 110 and is preferably sized to receive one or more types of interactive devices, such as, for purposes of illustration without limitation, and Palm Pilot® available from Palm Computing, Inc., USA.

Preferably, the optional or preferred retainer is configured to form a pocket that can receive and releasably retain the interactive data device whereby the device can be operated when so retained and used in conjunction with the various indicia of the indicia sheets 200, 205, 210, 215. In other alternative arrangements, the retainer device may also incorporate one or more features to releasably retain a stylus or similar component, such as that used by a Palm Pilot® or other interactive data device to interactively operate the device. Preferably the interactive data device can be configured with additional depictions and descriptive indicia such as those already illustrated and described herein.

In yet another alternative arrangement suitable for use with any of the preceding embodiments, either alone or in combination therewith, at least one of the plurality of pocket pages 185 can be optionally or preferably adapted to have at least one retainer to releasably receive the at least one interactive data device. In this way, one or more such interactive data devices may be incorporated into the contemplated communication assist device 100 this particular configuration may be especially supportive for teaching and learning applications where an instructor may include one interactive data device that is programmed as a teaching device as already noted herein elsewhere.

With continued reference to the various figures, and with specific reference to FIGS. 1 and 4, the communication assist device 100 can incorporate at least one or an entire indicia sheet of one or more or at least one audio emitting device 300 that can be an audio playback device. The contemplated device 300 can be a battery operated, push button 305 actuated audio device 300 that can emit, for purposes of example without limitation, a 4-bit, 8-bit, or other format audio segment. Such an audio segment can be a prerecorded sound, phoneme, word, phrase, or sentence or other desired sound or audio segment that may be useful for learning, teaching, and augmentative communication applications.

The audio device 300 may also be adapted with one or more mode switches 310 whereby it can interactively be changeably configured to record a sound, and then to playback the recorded sound. Additionally, the preferred or optional audio device 300 may be configured to playback preprogrammed audio segments (such as “yes” or “no,” see, e.g., FIGS. 1 and 4) as well as record and playback other desired audio segments (see, e.g., the exemplary mode switch labels of device 300 in FIG. 4). Although not shown in detail in the various figures, those skilled in the art may be able to understand with continued reference to FIG. 1 and indicia sheet 205 thereon, that at least one of the pockets pages 185 can be preferably or optionally formed with one or more holes (not shown but positioned proximate to and registered about the buttons 305 of device 300).

Numerous alterations, modifications, and variations of the preferred embodiments, configurations, modifications, variations, and alternatives disclosed herein will be apparent to. those skilled in the art and they are all contemplated to be within the spirit and scope of the instant invention. For example, while specific embodiments are described in detail, those having skill in the relevant arts may be able to appreciate that the preceding embodiments and variations can be further modified to incorporate various types of substitute and/or additional materials, components, shapes, indicia, relative arrangements of elements, and dimensional and proportional configurations for compatibility with the wide variety of desired communication augmentative applications and uses and for use with a wide range of contemplated users that may be experiencing one or more various verbalization, vocalization, language, speech, and communication challenges. Accordingly, even though only few variations of the present invention are described herein, it is to be understood that the practice of such additional modifications and variations and the equivalents thereof, are within the spirit and scope of the invention as defined in the following claims.

We claim:

1. A communication assist device, comprising:
a cover formed with a front and a back portion joined longitudinally about a spine, the cover incorporating a preselected pattern indicia and secured to a lateral carrying strap;
a plurality of pocket pages formed from a substantially transparent sheet material and bound about respective inside edges to the cover proximate the spine and each pocket pages of the plurality being formed with at least one aperture that opens into an interior interstice;
a plurality of indicia sheets sized for receipt through the aperture to be retained in the interstice to be observable through the pocket page sheet material, each of the plurality of indicia sheets being imprinted with a plurality of indicia selected from at least one category of indicia that includes an alphabet, a character set, numbers, arithmetic and mathematical symbols, dimension measurement units, metaphoric icons, images, pictures, graphics, symbols, glyphs, phonemes, words, phrases, sentences, wherein such categories of indicia are preselected to depict people, places, things, actions, activities, weather, food, emotions, business, academics, sports, and medicine and healthcare.

2. The communication assist device according to claim 1, wherein the cover further incorporates at least one retainer for releasably receiving at least one interactive data device.

3. The communication assist device according to claim 1, wherein at least one of the plurality of pocket pages is further adapted with at least one retainer for releasably receiving at least one interactive data device.

4. The communication assist device according to claim 1, wherein at least one of the plurality of pocket pages is replaced with at least one retainer for releasably receiving at least one interactive data device, the at least one retainer being attached about an inside edge to the spine of the cover.

5. The communication assist device according to claim 1, wherein at least one of the plurality of imprinted indicia are replaced with at least one audio playback device actuatable to emit at least one audio segment.

6. The communication assist device according to claim 5, wherein at least one of the pockets pages of the plurality is formed with one or more holes into the interstice and positioned to, when an indicia sheet of the plurality is received in the interstice, register over the at least one audio playback device so that the playback device is actuatable through the one or more holes.

7. The communication assist device according to claim 1, wherein at least one of the plurality of pocket pages is releasably attached to the spine and wherein the strap is adapted to be interchangeably connected to the cover whereby the communication assist device can be carried from the strap in a spine inferior and a spine superior orientation, the cover further incorporating at least one closure element for releasably securing the front and back portions of the cover in a confrontingly closed arrangement to sandwich the plurality of pocket pages therebetween, whereby the assist device occupies an envelope that is between approximately 4 inches in a lateral dimension and 6 inches in a longitudinal dimension.

8. A communication assist device, comprising:
a cover formed with a front and a back portion joined longitudinally about a spine, the cover incorporating a preselected pattern indicia and secured to a lateral carrying strap;
a plurality of pocket pages formed from a substantially transparent sheet material and bound about respective inside edges to the cover proximate the spine and each pocket pages of the plurality being formed with at least one aperture that opens into an interior interstice;
a plurality of indicia sheets sized for receipt through the aperture to be retained in the interstice to be observable through the pocket page sheet material, at least one of the plurality of indicia sheets including one or more audio playback devices and being imprinted with a plurality of indicia selected from at least one category of indicia that includes an alphabet, a character set, numbers, arithmetic and mathematical symbols, dimension measurement units, metaphoric icons, images, pictures, graphics, symbols, glyphs, phonemes, words, phrases, sentences, wherein such categories of indicia are preselected to depict people, places, things, actions, activities, weather, food, emotions, business, academics, sports, and medicine and healthcare.

10. The communication assist device according to claim 9, wherein the cover further incorporates at least one retainer for releasably receiving at least one interactive data device.

11. The communication assist device according to claim 9, wherein at least one of the plurality of pocket pages is further adapted with at least one retainer for releasably receiving at least one interactive data device.

12. The communication assist device according to claim 9, wherein at least one of the plurality of pocket pages is replaced with at least one retainer for releasably receiving at least one interactive data device, the at least one retainer being attached about an inside edge to the spine of the cover.

13. The communication assist device according to claim 9, wherein the one or more audio playback devices are actuatable to emit at least one audio segment.

14. The communication assist device according to claim 13, wherein at least one of the pockets pages of the plurality is formed with one or more holes into the interstice and positioned to, when an indicia sheet of the plurality is received in the interstice, register over the at least one audio playback device so that the playback device is actuatable through the one or more holes.

15. The communication assist device according to claim 9, wherein at least one of the plurality of pocket pages is releasably attached to the spine and wherein the strap is adapted to be interchangeably connected to the cover whereby the communication assist device can be carried from the strap in a spine inferior and a spine superior orientation, the cover further incorporating at least one closure element for releasably securing the front and back portions of the cover in a confrontingly closed arrangement to sandwich the plurality of pocket pages therebetween.

16. A communication assist device, comprising:
a cover formed with a front and a back portion joined longitudinally about a spine, the cover incorporating a preselected pattern indicia and secured to a lateral carrying strap and being formed with a retainer for releasably receiving at least one interactive data device;
a plurality of pocket pages formed from a substantially transparent sheet material and bound about respective inside edges to the cover proximate the spine and each pocket pages of the plurality being formed with at least one aperture that opens into an interior interstice;
a plurality of indicia sheets sized for receipt through the aperture to be retained in the interstice to be observable through the pocket page sheet material, each of the plurality of indicia sheets being imprinted with a plurality of indicia selected from at least one category of indicia that includes an alphabet, a character set, numbers, arithmetic and mathematical symbols, dimension measurement units, metaphoric icons, images, pictures, graphics, symbols, glyphs, phonemes, words, phrases, sentences, wherein such categories of indicia are preselected to depict people, places, things, actions, activities, weather, food, emotions, business, academics, sports, and medicine and healthcare.

17. The communication assist device according to claim 16, wherein at least one of the plurality of pocket pages is releasably attached to the spine and wherein the strap is adapted to be interchangeably connected to the cover whereby the communication assist device can be carried from the strap in a spine inferior and a spine superior orientation, the cover further incorporating at least one closure element for releasably securing the front and back portions of the cover in a confrontingly closed arrangement to sandwich the plurality of pocket pages therebetween.

18. The communication assist device according to claim 16, wherein at least one of the plurality of pocket pages is further adapted with at least one retainer for releasably receiving another interactive data device.

19. The communication assist device according to claim 16, wherein at least one of the plurality of imprinted indicia are replaced with at least one audio playback device actuatable to emit at least one audio segment.

20. The communication assist device according to claim 19, wherein at least one of the pockets pages of the plurality is formed with one or more holes into the interstice and positioned to, when an indicia sheet of the plurality is received in the interstice, register over the at least one audio playback device so that the playback device is actuatable through the one or more holes.
